(19) United States
(12) Patent Application Publication
(10) Pub. No.: US 2009/0135484 A1
(43) Pub. Date: May 28, 2009

(54) LENS WITH VARIABLE FOCAL LENGTH AND SYMMETRY

(76) Inventors: Etienne N. Weber, Puligny Montrachet (FR); Nicolas P. Touchard, Suresnes (FR)

Correspondence Address: EASTMAN KODAK COMPANY;PATENT LEGAL STAFF, 343 STATE STREET, ROCHESTER, NY, 14650-2201, US

(21) Appl. No.: 11/577,996

(22) PCT Filed: Oct. 28, 2005
(86) PCT No.: PCT/EP05/11549

§ 371 Date: Apr. 26, 2007

(30) Foreign Application Priority Data
Nov. 8, 2004 (FR) 04/11840

(51) Int. Cl. G02B 27/64; G02B 3/14

(52) U.S. Cl. 359/554; 359/666

(57) ABSTRACT

The invention relates to a variable focal length lens with a chamber (10) having symmetry of revolution around an axis (14) and containing one first transparent fluid (20) and one second transparent fluid (22) that have different optical indices and are immiscible, so as to form a meniscus (24), and that have different electrical conductivities, and means (30, 40) to modify the curvature of the meniscus.

According to the invention, the means to modify the curvature of the meniscus comprises means of applying an electric field dissymmetrical in relation to the axis of said chamber.

The invention has applications in the production of cameras.

### FIELD OF THE INVENTION

The present invention relates to lenses with variable focal length. More precisely, it relates to lenses formed by the combination of two transparent immiscible liquids, which have different optical indices and constitute a meniscus at their interface. The focal length of these lenses can be modified by means of an electric field applied to the liquids.

The possibility of quickly and easily modifying the focal length of the lenses, by means of an electric control, is particularly advantageous for all equipment in which it is difficult to integrate bulky optical systems or motors intended to move the optical systems mechanically.

The invention finds applications in the manufacture of lenses or optical equipments, and in particular recording equipment such as digital cameras or phonecams.

### BACKGROUND OF THE INVENTION

The state of the art is illustrated by documents (1) and (2), whose references are given at the end of the description.

The liquids forming the lens meniscus are contained in a chamber with symmetry of revolution, such as a cylindrical or conical chamber. Light rays cross the lens more or less parallel to its axis, by entering and leaving by the end surfaces of the cylinder or truncated cone. Thus, the meniscus formed by the liquids also has symmetry of revolution.

One of the fluids used is an insulating fluid whereas the second fluid is a conductor.

To modify the radius of curvature of the meniscus formed by the liquids, an electric field, capable of modifying the wettability of the liquids on the chamber wall, is applied to them. More precisely, the field is applied across the conductive liquid and an electrode located on the chamber and electrically insulated from the liquids.

The choice of liquids, the position of the electrodes, the shape of the chamber and the applied voltages determine the curvature of the meniscus. It is possible to modify, even to invert the curvature of the meniscus, and control the radius by acting on the applied electric field. Just like the chamber, the electrode has symmetry of revolution around the lens axis. Thus we obtain a regular meniscus also having symmetry of revolution around the chamber axis. This point is important for not distorting the images produced by the lens.

### SUMMARY OF THE INVENTION

The invention is based on the observation that, among lenses of the above-mentioned type, only small lenses enable images to be formed correctly. When the volume of the cylindrical chamber and liquids is too great, image distortion occurs. The distortion is mainly due to the effects of gravity which deform the liquids and break the symmetry of revolution of the meniscus around the chamber axis. In practice, lenses with variable focal length have diameters of only a few millimeters.

These lenses can thus only be used in equipment provided with very small image sensors, at the risk of having a clearly insufficient optical opening.

An additional difficulty comes from the fact that recording equipment capable of being equipped with lenses with variable focal length can be used in several different positions, corresponding, for example to landscape or portrait framing, or to overhead or low-angle shots. The disturbance of the image under the effect of gravity is thus variable.

It is the object of the invention to propose a variable focal length lens that does not have the above-mentioned difficulties.

One object in particular is to present such a lens that is freed from the effect of the Earth's gravity and whose opening diameter is not limited by this effect.

Another object is to free the lens, or an image formed by the lens, from vibrations, movements or accelerations imposed by the recording equipment which is equipped with it.

Yet another object is to propose a lens enabling an optical point to be made selectively on part of the optical field that it embraces.

To achieve these objects, more precisely the object of the invention is a variable focal length lens with:
A chamber having symmetry of revolution around an axis and containing one first transparent fluid and one second transparent fluid that are immiscible and have different optical indices, in order to form a meniscus, and that have different electrical conductivities, and
means to modify the curvature of the meniscus.

According to the invention, the means to modify the curvature of the meniscus comprises means of applying an electric field dissymmetrical in relation to the axis of said chamber.

The dissymmetrical field applied to the liquids can be used for various functions. The main function is to keep the symmetry of revolution of the meniscus around the chamber axis, despite the effects of gravity on the liquids. In other words, a more intense electric field can be applied to the liquids in the vertical direction, and in the opposite direction to the direction of gravity.

Another function can be to deliberately break the symmetry of revolution of the meniscus around the chamber axis in order to have a directional optical axis that is not necessarily in line with that of the lens chamber. In a camera, this enables the optical axis to be pointed automatically towards a region of interest selected in an image to be captured. A concomitant increase of this region is also possible by modifying the lens' overall focal length.

The basic structure of the variable focal length lens is that already described with reference to the state of the prior art. We can thus refer to documents (1) and (2) mentioned above as regards the immiscible liquids, the chamber, and the presence of one or more “main” electrodes intended to modify the curvature of the meniscus symmetrically. It should be noted that the liquids or fluids used to form the meniscus have different electrical conductivities. Preferably, one of the two liquids is a liquid comparable to an insulating liquid whereas the second liquid is comparable to a conductor. In the following description, the liquid having the weakest conductivity is called the insulating liquid, whereas the liquid having the highest conductivity is called the conductor liquid.

In a particular embodiment of a lens according to the invention, the means of applying a dissymmetrical electric field can comprise at least one annular electrode, radially segmented around the chamber, and means of selective application of at least one polarization voltage with at least one electrode segment, in order to locally modify the curvature of the meniscus.

The fact of selectively applying a polarization voltage to one of the electrode segments means raising this segment in a potential different from the potential or potentials applied to the other segments. This enables the dissymmetrical field to be created. More precisely, this is either a field without symmetry of revolution, or a field with symmetry of revolution but whose axis is not in line with the chamber axis, or parallel to it.

The polarization voltage selectively applied to one of the segments of the segmented electrode can be defined in relation to one or more other segments of the same electrode, in relation to a counter-electrode, in contact with the conductor liquid, or again in relation to a main electrode intended to apply a symmetrical field.

It is also possible to superimpose a main voltage, common to all the segments of the segmented electrode, to the selective polarization voltage. In this case, the use of a symmetrical and continuous main electrode is no longer necessary to modify the curvature of the meniscus. Indeed, the common component of the polarization applied to the segments then acts to modify the curvature of the meniscus symmetrically, whereas the selective voltage acts to apply a dissymmetrical field to compensate or cause a dissymmetrical distortion.

The terms “symmetrical” and “dissymmetrical” here mean in relation to the chamber axis.

The means of applying a dissymmetrical field, in particular the segmented electrode, can thus be or not combined with additional means of applying a symmetrical electric field. The means of applying a symmetrical electric field, in relation to the chamber axis, can comprise, if necessary, one or more continuous annular electrodes, centered on the axis, and arranged on a side wall of the chamber, or another electrode arranged on an end wall of the chamber.

According to another possible implementation of the invention, the means of applying a dissymmetrical electric field can comprise at least one continuous annular electrode, going around the chamber, and having a symmetry center that is off-centre in relation to the chamber axis, and means of applying a polarization voltage to the electrode.

One or more annular electrodes can extend or not in a plane perpendicular to the chamber axis.

The off-centering of the annular electrode has the effect of making the distance between the electrode and the liquids variable according to an angle measured around the chamber axis, and thus causing a dissymmetrical field.

The off-centered electrode can be continuous or segmented in order to combine the effects of both modes of implementation previously described.

The off-centered electrode can be single. Many off-centered electrodes can also be provided with various centers or eccentricities.

It should be noted that the off-centering of the annular electrodes can result either from the fact that the electrodes are not circular, but have an eccentricity, e.g. elliptic or oval, or from the fact that they are circular but their centre is not on the chamber axis.

According to yet another possible implementation of the invention, which is also not exclusive of the previous implementations, the lens can comprise at least one annular electrode centered on the chamber axis, going around the chamber in a plane forming an angle at 90° to the chamber axis, and the means of applying a polarization voltage to the electrode.

In this case, the electrode can be circular or not.

The angle made by the “inclined” electrode with the chamber axis means that the various parts of the ring it forms are at different distances from the conductor liquid or a counter-electrode in electrical contact with the liquid.

In a way comparable with the other modes of implementation, a dissymmetrical electric field can be caused by applying a voltage across the inclined electrode and a counter-electrode or a main electrode of the lens.

Certain recording equipment, in particular fixed equipment, such as surveillance cameras, is always subjected to gravity in the same way. A correcting dissymmetrical electric field can thus be preset to effectively correct any distortion of the liquid lens. However, portable equipment, such as cameras, may be used in various positions. The effect of gravity on the lens is thus variable.

To take account of variations of the gravity effect, the lens according to the invention can be equipped with means of detecting any anisotropic distortion of the meniscus towards part of the chamber wall. In this case, the means of detecting a distortion are connected to the means of applying a dissymmetrical electric field, in order to create a field with a dissymmetrical component opposing the distortion. More precisely, this is a component in the distortion direction, and opposed to the distortion.

The means of detection, combined with the means to create a dissymmetrical field, constitute an automatic correction servo system. This enables the symmetry of revolution of the lens to be kept in order not to distort images formed through the lens, despite camera movements.

It should be noted that the servo linking and curvature correction of the lens meniscus are useful not only to correct for the effects of gravity, but also for any other acceleration resulting, for example, from vibrations or movements made by a camera.

The means of detecting the distortion of the meniscus can comprise, for example, a segmented electrode arranged around the chamber and at least a capacitance meter to measure an electric capacitance between each of the electrode segments and a reference electrode.

The reference electrode is an electrode in contact with the conductor liquid or possibly with the main electrode. The conductor liquid on the one hand, and each of the segments of the segmented electrode, on the other hand, respectively constitute capacitor plates. The dielectric of these capacitors includes the chamber's insulating wall and one part of the non-conductor liquid.

Thus, a distortion of the meniscus has the effect of increasing the thickness of the dielectric for some capacitors and reducing it for others. The electric capacities measured on the segments are thus modified by a dissymmetrical movement of the conductor liquid and thus enable the distortion of the meniscus to be quantified. The capacitance meter measurements supply a control signal for the means of forming the correcting electric field.

According to another possibility, the means of detecting the distortion can comprise at least one light source combined with optics to direct controlling light beams through the lens towards a matrix sensor sensitive to the movement of the light beam under the effect of a distortion of the meniscus. The matrix sensor is, for example, the image sensor of the recording equipment equipped with the lens. The sensor is connected to the means of applying a dissymmetrical electric field to control the application of the field.

In this case the effect of a dissymmetrical distortion of the meniscus on the transmission of light is used directly to provide the necessary correction.

According to yet another possibility, the means of detecting a distortion of the meniscus can comprise an accelerometer, sensitive in a plane perpendicular to the chamber's optical axis, to detect the direction of the acceleration in this plane; the accelerometer being connected with the means of applying an electric field to control the making of a correcting electric field with a dissymmetrical component in the direction of the acceleration of gravity, to counter the distortion of the meniscus under the influence of the acceleration. The detected acceleration can be any acceleration experienced by the lens, and in particular the acceleration due to gravity.

The means using an accelerometer are not direct means of detecting the distortion, but indirect means. Indeed, they detect the cause of the distortion.

In particular, and in a simplified way, by detecting the line and direction of gravity, the accelerometer enables the type of framing to be determined, portrait or landscape, in order to adapt the orientation of the dissymmetry of the applied electric field.

An accelerometer can be also provided with sensitivity in an axis parallel to the chamber axis. The accelerometer is then connected to the means of applying a dissymmetrical electric field, to control the amplitude of the field, in particular the amplitude of the polarization voltages to be applied. The amplitude of the voltages is inversely proportional to the acceleration experienced by the accelerometer in the chamber axis.

Indeed, the amplitude of the correcting field to be provided is maximum when the camera's lens axis is more or less horizontal, because, in this case, the direction of gravity is perpendicular to the axis.

However, when the lens axis is more or less vertical, for example when the device is pointed upwards, gravity does no longer distorts the meniscus in a dissymmetrical way, and the correcting electric field can be minimum or zero.

Several accelerometers can be used. However, an accelerometer with three axes of sensitivity is suited to supplying the necessary signals to determine simultaneously the line, direction and amplitude of the dissymmetrical field required to counter the acceleration experienced by the lens.

Other characteristics and advantages of the invention will appear in the following description, with reference to the figures of the appended drawings. This description is given purely as an illustration and is not limiting.

### BRIEF DESCRIPTION OF THE DRAWINGS

FIG. 1 is a simplified schematic representation of a variable focal length lens according to the invention, illustrating a first embodiment.

FIG. 2 is a simplified schematic representation of a variable focal length lens according to the invention, illustrating another embodiment.

FIG. 3 is a simplified schematic representation of a variable focal length lens according to the invention, illustrating yet another embodiment.

FIG. 4 is a simplified schematic representation of a variable focal length lens according to the invention, illustrating yet another embodiment.

FIG. 5 is a simplified schematic representation of a variable focal length lens according to the invention, illustrating various control possibilities of a correcting electric field.

### DETAILED DESCRIPTION OF THE INVENTION

In the following description, identical, similar or equivalent parts of the various figures are marked with the same reference symbols to facilitate reference between the images.

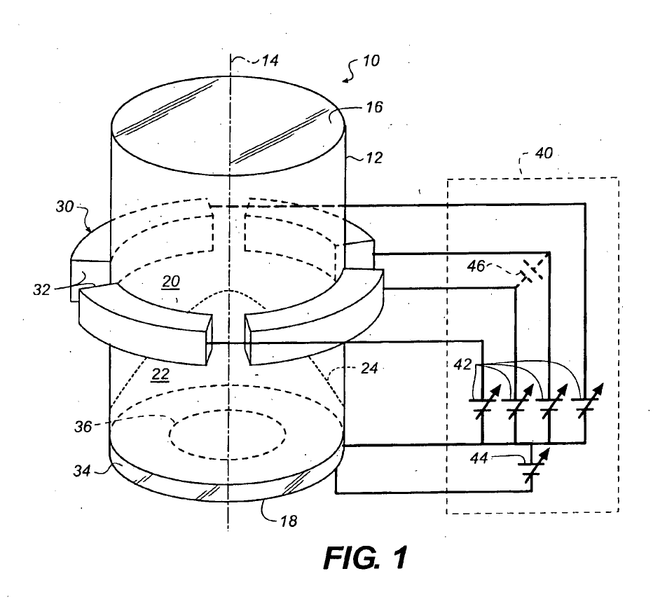

The variable focal length lens of FIG. 1 comprises a chamber 10 in the form of a straight cylinder, with a side wall 12 extending parallel to its axis 14, and with end walls 16 and 18 perpendicular to the axis 14.

The end walls are made of light transparent material and constitute the entry and exit surfaces of the lens. The entry and exit surfaces can in particular be comprised of solid fixed focal length lenses. The side wall 12 is preferably made of an electric insulating material.

An annular electrode 30, formed of several segments 32 mutually isolated, is arranged around the chamber 10. More precisely the segments are arranged against the side wall 12 which thus acts as an electric insulating support. The number of segments is preferably greater than or equal to three.

The lens contains a first transparent electric insulating liquid 20, such as a silicon oil or an alkane, and a second transparent electric conductor liquid 22, immiscible with the first, with a different optical index. For example, this is an aqueous solution of a salt or any other conductor liquid. Preferably, the first and second liquids have similar densities.

At their interface the liquids form a meniscus 24.

A counter-electrode 34 is arranged on an end wall 18, or constitutes it, in order to be in electric contact with the conductor liquid 22. The counter electrode 34 is made of a transparent conductor material, e.g. indium tin oxide (ITO), and covers the whole wall 18. In other embodiments, it can also constitute the wall. When the counter-electrode is opaque, a central opening, or a transparent light passage 36, can be provided.

The segmented electrode 30, in combination with the counter electrode 34, has a dual role. A first role is to create a variable, more or less symmetrical, electric field around the axis 14. This field modifies the wettability of the liquids on the wall 12 and causes a uniform and axially symmetrical distortion of the meniscus 24 that modifies the focal length of the lens.

According to another embodiment of the device, this first role could be assigned to a continuous electrode, added to the segmented electrode.

The second role of the segmented electrode is to form a dissymmetrical electric field that overlaps the existing symmetrical field or replaces it. The dissymmetrical electric field can be used to cause a deliberate distortion of the meniscus 24 to make it dissymmetrical as well. This enables the optical axis of the lens to be revolved in relation to the axis of symmetry 14.

It is also possible to use the dissymmetrical field to counter an external force acting on the liquids, which would tend to distort the meniscus. In this case, the dissymmetrical field has the effect of returning the meniscus to its symmetrical shape and countering the forces or accelerations experienced by the liquids.

Both functions of the dissymmetrical electric field, in this case the function of correcting and that of revolving the optical axis, can be combined.

An electric control module 40 of the electrodes is represented in a very simplistic way. Several voltage sources 42 are connected between the counter-electrode 34 and each of the segments 32 of the segmented electrode respectively. The variable voltage sources enable the various segments to be raised to various potentials.

In a simplified embodiment, a single voltage source applied selectively to one of the segments, can be enough to create a dissymmetrical field. A greater number of sources and electrode segments, however, enables the profile of the dissymmetrical field to be controlled more finely.

A common voltage source 44 can be also be provided to shift the potential of the segments of the segmented electrode overall and thus control the curvature of the meniscus and the focal length of the lens.

Finally, voltages can be applied directly across the segments of the segmented electrode, as shown by a voltage source 46 represented with a broken line.

It should be noted that the polarity of the voltage sources represented on the figure are given for illustration only and can, if necessary, be reversed.

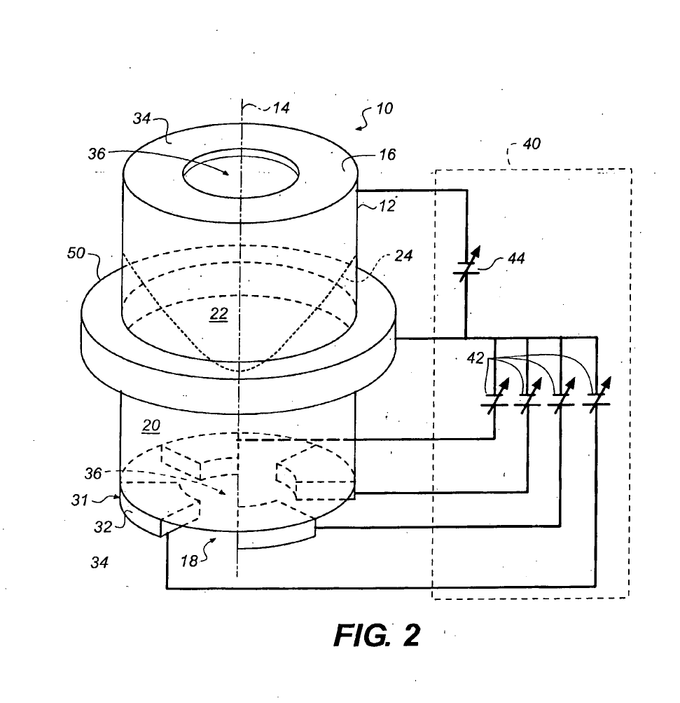

FIG. 2 shows a second possible embodiment of a lens according to the invention.

A variable voltage source is connected across the counter-electrode 34 and the main annular electrode.

The main, continuous electrode, is arranged on side of the chamber and enables an adjustable symmetrical electric field to be created to control the adjustment of the focal length of the lens.

The counter-electrode is formed on one of the end walls 16. It is in electrical contact with the conductor liquid.

A radially segmented electrode 31 is arranged on the opposite end wall 18. Preferably it is arranged on the outside of the wall, to remain electrically isolated from the liquids contained in the chamber.

The segments, 32 of the electrode 31, are arranged around a light passage 36. This enables an opaque metal to be used for their production.

The voltage sources 42 of the electric control module 40 are connected across the main electrode and the segments of the segmented electrode to add (or subtract) the selective voltages to (from) the voltage of the common voltage source 44.

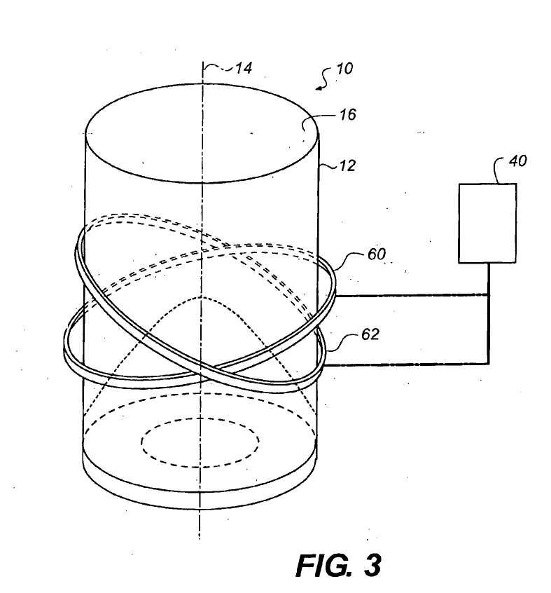

FIG. 3 illustrates, in a simplified way, yet another possible embodiment of the means of applying a dissymmetrical field. The side wall 12 of the chamber 10 is surrounded by continuous annular electrodes 60 and 62 that are mutually isolated. However, these do not extend perpendicularly to the chamber axis, but in planes that make an angle of 90° to this axis. The tilted annular electrodes are connected to a module 40, comparable to that of the previous figures, in order to raise the electrodes to various electrical potentials in relation to a counter-electrode or another electrode taken as reference.

A single tilted annular electrode can be enough to cause a dissymmetrical field. However, preferably many such electrodes with various tilt angles are provided.

For reasons of simplification, one or more main electrodes intended to produce a symmetrical field are also omitted from the figure. Such electrodes are however provided for controlling the focal length.

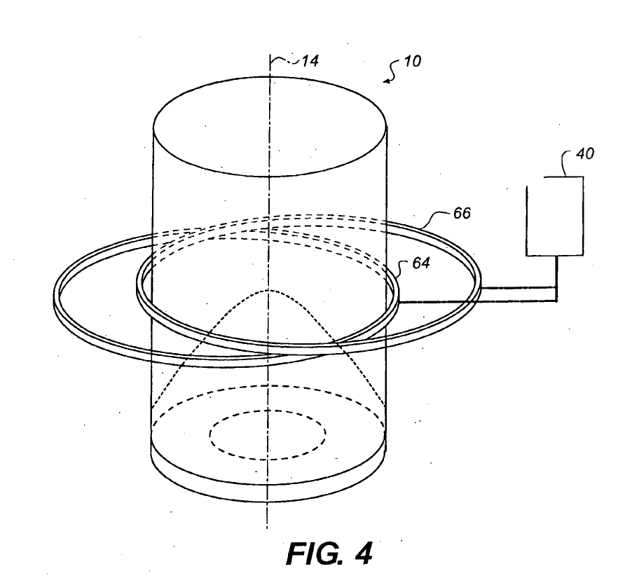

In a way comparable to FIG. 3, FIG. 4 shows yet another possible embodiment of the lens. Annular electrodes 64 and 66 are no longer tilted in relation to the axis 14 of the chamber, but are perpendicular to it. However, electrodes 64 and 66 are off-centered. In this case these are circular electrodes whose diameter is greater than that of the chamber and whose centre of a symmetry is shifted in relation to the chamber axis 14. Thus, when a potential difference is applied across an off-centered electrode and a reference electrode, as described above, a dissymmetrical electric field is created. As a variant, electrodes 64 and 66 can be non-circular, but be eccentric.

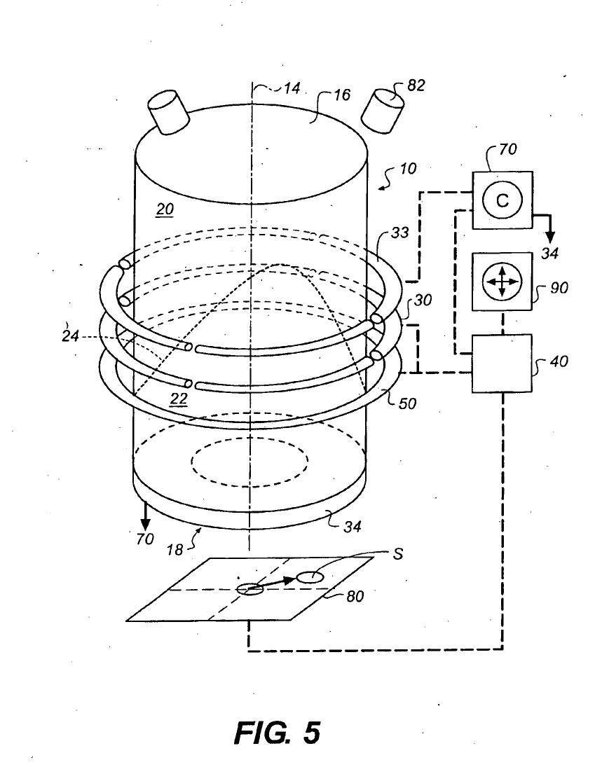

Whatever the mode of embodiment of the lens, the means of creating a dissymmetrical field and the electric control module 40 can be controlled to point the optical axis of the lens towards a region of interest of an image captured by a sensor through this lens. The same means can also be controlled to counter any distortion of the meniscus, under the effect of gravity on the liquids or under the effect of acceleration. In this case, specific means are planned to establish the line and direction of the correcting field to be provided. FIG. 5 illustrates such means that can be implemented separately or in combination.

A first means is intended to detect a distortion of the meniscus. It comprises a circular segmented electrode 33 going around the lens, in contact with the chamber wall, in a region bordering the isolating liquid of the lens. This is an electrode quite similar to the segmented electrode 30, described with reference to FIG. 1, for applying a dissymmetrical field. It is called “capacitance meter electrode”.

Each segment of the capacitance meter electrode 33 is connected to a capacitance meter 70. The capacitance meter 70 measures an electric capacity across each segment of the electrode 33 and a counter-electrode 34 in contact with the conductor liquid. Indeed, each segment of the capacitance meter electrode constitutes a capacitor plate whose second plate is the conductor liquid, and whose insulating liquid is the dielectric. In this case the chamber's insulating wall also forms part of the dielectric.

When the meniscus distorts in the direction of one or more segments, the conductor liquid approaches this segment and the thickness of the dielectric decreases locally. The electric capacitance measured for the relevant electrode segments consequently increases, whereas it decreases for the segments located opposite.

The measurements made by the capacitance meter for the various segments are converted into a control signal. The signal is supplied to the electric control module 40 to control the voltages applied to the segmented electrode 30 with the aim of creating a correcting dissymmetrical field. A stronger field is applied, for example, in regions where the measured electric capacitance is weaker.

FIG. 5 represents the capacitance meter electrode 33, the segmented electrode 30 for forming a dissymmetrical field and a main electrode 50 for applying a symmetrical electric field. However, it should be noted that a single segmented electrode can be used for the three functions or for two of the three functions.

Another means intended to detect any distortion of the meniscus comprises an image sensor 80 arranged behind the lens. This is, for example, a matrix sensor of the type equipping the digital cameras. Combined with the sensor are one or more optical systems 82, arranged on the side opposite the lens, projecting the image of a lit object, for example a light source, through the lens onto the sensor 80. In the example of FIG. 5, the image sensor is located near the end wall 18 whereas the two optical systems 82 are located near the end wall 16 of the lens. The optical systems project, for example, the image of a uniform light source onto the sensor through the lens, to form a spot.

When the meniscus 24 distorts, as shown in FIG. 5, a bright spot projected onto the sensor 80 moves. The direction and amplitude of the movement of the spot are taken into account to supply a correction signal to the electric control module 40. In a camera, the measurement of the spot's movement is made periodically, and preferably just before each shot, to determine the necessary corrections.

The optical system 82 can advantageously be produced from a laser source.

A third means, useful to establish a possible correction field, detects any distortions of the meniscus indirectly. This is an accelerometer 90. The accelerometer has three different axes of sensitivity, preferably normal to one another. The accelerometer delivers a measurement signal for each axis. It is sensitive not only to the acceleration of gravity, but also to the artificial accelerations caused by the user to the equipment provided with the lens. A first linear combination of the signals according to each axis is used to determine acceleration in a plane perpendicular to the chamber axis. The second linear combination is used to determine the acceleration in line with the chamber axis. The choice of linear combinations depends on the orientation of the axes of sensitivity in relation to the axis 14 of the lens chamber. When one of the axes of sensitivity is parallel to the chamber axis, the signal for this axis can be used directly to control the strength of the correction field. Perpendicular axes are then used to fix the line and direction of the dissymmetrical correction field.

### CITED DOCUMENTS

(1) EP-B-1 019 758
(2) WO-03/069380

1) A variable focal length lens comprising: a chamber having symmetry of revolution around an axis and containing one first transparent fluid and one second transparent fluid that are immiscible and have different optical indices, so as to form a meniscus, and that have different electrical conductivities, and means to modify the curvature of the meniscus, characterized in that wherein the means to modify the curvature of the meniscus comprise means of applying an electric field dissymmetrical in relation to the axis of said chamber.

2) A lens according to claim 1, wherein the means of applying a dissymmetrical electric field comprise at least one electrode, radially segmented around the chamber, and means for selectively applying at least one polarization voltage to at least one segment of the electrode.

3) A lens according to claim 2, comprising one counter-electrode combined with the radially segmented electrode.

4) A lens according to claim 2, wherein the segmented electrode (30) is circular and arranged around the chamber in a centered way on the chamber axis.

5) A lens according to claim 2, wherein the segmented electrode is arranged against one wall of the chamber perpendicular to the chamber axis.

6) A lens according to claim 1 further comprising a means of applying a symmetrical electric field according to the chamber axis.

7) A variable focal length lens according to claim 1, wherein the means of applying a dissymmetrical electric field comprise at least one annular electrode, off-centered in relation to the chamber axis, and means of applying a polarization voltage to the annular electrode.

8) A variable focal length lens according to claim 1, wherein the means of applying an electric field comprise at least one annular electrode, going around the chamber in a plane forming an angle of 90° to the chamber axis, and means of applying a polarization voltage to the electrode.

9) A lens according to claim 1, further comprising at least one accelerometer sensitive to accelerations in a plane perpendicular to the axis, the accelerometer being connected to the means of applying an electric field to control the making of a correcting electric field with a dissymmetrical component, to counter distortion of the meniscus under the effect of the accelerator.

10) A lens according to claim 9, further comprising at least one accelerometer sensitive in an axis parallel to the chamber axis, wherein the accelerometer is connected to the means of applying a dissymmetrical electric field, to control the amplitude of said dissymmetrical field.

11) A lens according to claim 1, further comprising means for detecting an anisotropic distortion of the meniscus towards part of the chamber wall, and wherein the means of detecting a distortion are connected to the means of applying a dissymmetrical electric field, to create a field having a component in line with the distortion, and a direction opposing the distortion.

12) A lens according to claim 11, wherein the means of detecting the distortion of the meniscus comprise a segmented electrode arranged around the chamber and at least one capacitance meter to measure an electric capacitance between each of the electrode segments and a reference electrode.

13) A lens according to claim 11, wherein the means of detecting the distortion comprise at least one light source to direct a controlling light beam through the lens, and a matrix sensor sensitive to the movement of the light beam under the effect of a distortion of the meniscus, the sensor being connected to the means of applying a dissymmetrical electric field to control the application of the field.
